(19) United States
(12) Patent Application Publication
(10) Pub. No.: US 2025/0026190 A1
(43) Pub. Date: Jan. 23, 2025

(54) WEATHER STRIP RETENTION SYSTEM FOR TRANSITION PORTIONS OF A SUNROOF ASSEMBLY

(71) Applicant: AISIN Corporation, Kariya Aichi (JP)

(72) Inventors: Glover Allen Kosch, Ann Arbor, MI (US); Michael Arthur Mixon, Brighton, MI (US); Jacob Celina Grimaldo, Westland, MI (US); Christian James Romans, Livonia, MI (US)

(21) Appl. No.: 18/353,138

(22) Filed: Jul. 17, 2023

(51) Int. Cl. B60J 10/30; B60J 10/70

(52) U.S. Cl. CPC B60J 10/30; B60J 10/70

(57) ABSTRACT

A system structured to retain a weather seal along a transition portion of a vehicle sunroof assembly. The system includes a first weather seal retaining structure structured to be positioned between a second weather seal retaining structure extending at least partially along a first side of the sunroof assembly and a third weather seal retaining structure extending at least partially along a second side of the sunroof assembly adjacent the first side. In particular arrangements, another weather seal retaining structure may be positioned to extend between the second weather seal retaining structure and the third weather seal retaining structure, adjacent the first weather seal retaining structure. In combination, the weather seal retaining structures operate to effectively retain the weather seal along a transition portion of the sunroof assembly.

### TECHNICAL FIELD

The embodiments disclosed herein relate to sunroof assemblies for vehicles and, more particularly, to structures for retaining a weather seal along corners or intersection of the sunroof assembly.

### BACKGROUND

In some sunroof assemblies, due to component and system design requirements, it has proven difficult to adequately secure a weather seal of the sunroof assembly along corners or transition portions of the sunroof assembly. This may lead to the weather seal becoming detached from the sunroof assembly along the transition portions during sunroof operation or over time, due to wear, wind, etc.

### SUMMARY

In one aspect of the embodiments described herein, a system structured to retain a weather seal along a transition portion of a vehicle sunroof assembly is provided. The system includes a first weather seal retaining structure structured to be positioned between a second weather seal retaining structure extending at least partially along a first side of the sunroof assembly and a third weather seal retaining structure extending at least partially along a second side of the sunroof assembly adjacent the first side.

### BRIEF DESCRIPTION OF THE DRAWINGS

The accompanying drawings, which are incorporated in and constitute a part of the specification, illustrate various systems, methods, and other embodiments of the disclosure. It will be appreciated that the illustrated element boundaries (e.g., boxes, groups of boxes, or other shapes) in the figures represent one embodiment of the boundaries. In some embodiments, one element may be designed as multiple elements or multiple elements may be designed as one element. In some embodiments, an element shown as an internal component of another element may be implemented as an external component and vice versa. Furthermore, elements may not be drawn to scale.

It will be appreciated that for simplicity and clarity of illustration, where appropriate, reference numerals may have been repeated among the different figures to indicate corresponding or analogous elements. Also, similar reference numerals appearing in different views may refer to similar elements appearing in those views. In addition, the discussion outlines numerous specific details to provide a thorough understanding of the embodiments described herein. Those of skill in the art, however, will understand that the embodiments described herein may be practiced using various combinations of these elements.

FIG. 1 is a schematic perspective view of a sunroof assembly for a vehicle, in accordance with an embodiment described herein.

FIG. 2 is a magnified schematic view of a portion of a transition portion of the sunroof assembly shown in FIG. 1

FIG. 3 is a magnified schematic perspective view of a portion of a housing of the sunroof assembly, in accordance with an embodiment described herein.

FIG. 4 is a schematic perspective view of an inner guide block in accordance with an embodiment described herein, shown coupled to a guide rail of the sunroof assembly.

FIG. 5 is a schematic perspective view of an inner guide block and an outer guide block of the sunroof assembly, and showing the inner guide block and the outer guide block coupled together by a tongue-and-groove arrangement.

FIG. 6 is a schematic perspective view similar to the view of FIG. 5, with the housing, inner guide block, and outer guide block of the weather seal retention system shown in their relative positions in the sunroof assembly.

FIG. 7 is a schematic perspective view similar to the view of FIG. 6, showing a weather seal secured to the elements of the weather seal retention system.

FIG. 8 is a schematic perspective view of a retaining structure in accordance with an embodiment described herein.

FIG. 9 is a partial cross-sectional view showing a weather seal mounted and retained on the retaining structure of FIG. 8, and showing details of the weather seal.

### DETAILED DESCRIPTION

This disclosure relates to a system structured to retain a weather seal along a transition portion of a vehicle sunroof assembly. The system includes a first weather seal retaining structure structured to be positioned between a second weather seal retaining structure extending at least partially along a first side of the sunroof assembly and a third weather seal retaining structure extending at least partially along a second side of the sunroof assembly adjacent the first side. In particular arrangements, another weather seal retaining structure may be positioned to extend between the second weather seal retaining structure and the third weather seal retaining structure, adjacent the first weather seal retaining structure. In combination, the weather seal retaining structures operate to effectively retain the weather seal along a transition portion of the sunroof assembly.

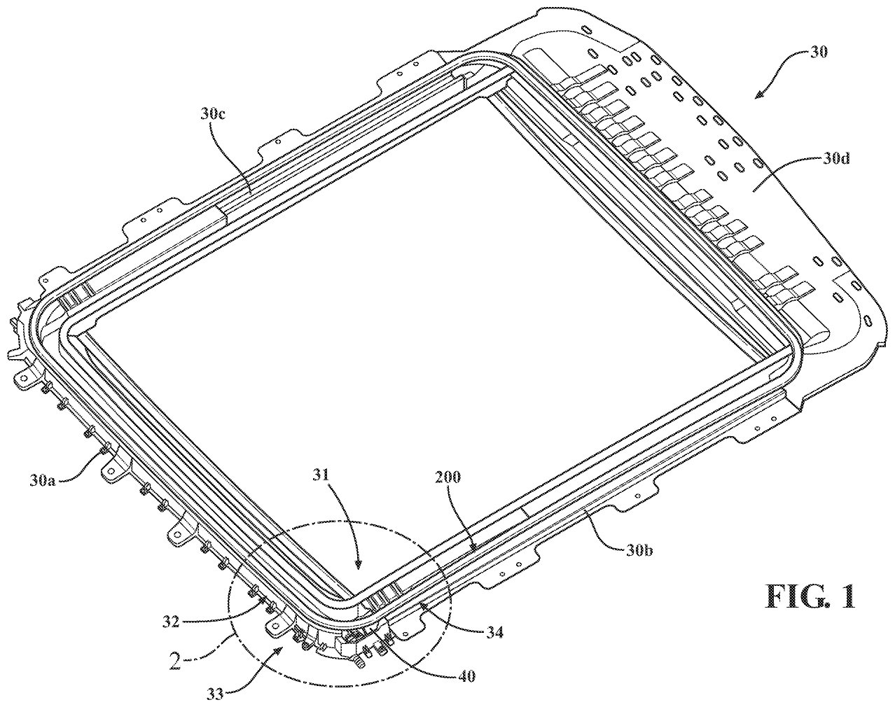

For purposes described herein, a “sunroof assembly” may be defined as including a vehicle Sunroof and also any component or sub-assembly mounted on (or adjacent to) a vehicle roof, that enables or facilitates operation (e.g., raising, lowering, opening, closing, etc.) of the sunroof. Referring to FIG. 1, the sunroof assembly 30 may have various sides, with each side structured to be positioned and secured along an associated edge of a sunroof opening (not shown) formed in the vehicle roof. For example, the assembly 30 may have a front side 30a structured to extend along a front edge of the sunroof opening, a left side 30b structured to extend along a left edge of the sunroof opening, a right side 30c structured to extend along a right edge of the sunroof opening, and a rear side 30d structured to extend along a rear edge of the sunroof opening. The sunroof assembly may also include one or more weather seals 200 to help prevent entry of moisture and contaminants into the vehicle occupant compartment and into sensitive components and mechanisms of the sunroof assembly 30.

FIG. 1 also shows a transition portion 31 of the sunroof assembly highlighted. A “transition portion” of the sunroof assembly may be defined as a portion of the sunroof assembly connecting one side (e.g., the left side) of the assembly to another side (e.g., the front side) of the assembly. Thus, the “transition portion” is effectively a “corner” of the sunroof assembly. In some sunroof assemblies, due to component and system design requirements, it has proven difficult to adequately secure a weather seal of the sunroof assembly along transition portions of the sunroof assembly. This may lead to the weather seal becoming detached from the sunroof assembly along one or more transition portions of the assembly.

The present disclosure describes embodiments of a weather seal retention system structured to retain a weather seal along a transition portion of a vehicle sunroof assembly. For purposes of description, aspects of the weather seal retention system will be described as applied to the transition portion 31 highlighted in FIG. 1. However, it will be understood that the description set forth also applies to any other transition portions of the sunroof assembly.

Referring to FIGS. 1-3, the weather seal retention system 33 may include a housing 32 structured to be positionable along a first side (in the embodiment shown, the front side 30a) of the sunroof assembly 30. In the embodiment shown, the housing 32 is a front housing of the sunroof assembly. The front housing 32 may be secured to a vehicle roof along a front edge of a sunroof opening (not shown). The front housing 32 may be structured to facilitate seating and securement of a movable glass panel (not shown) of the sunroof assembly 30 when the glass panel is in a closed position of the sunroof. The housing 32 may also be structured to perform other functions. The housing 32 may include a base portion 32a and a support portion 32b extending from the base portion. In one or more arrangements, the support portion 32b may be structured to support a weather seal retaining structure as described herein

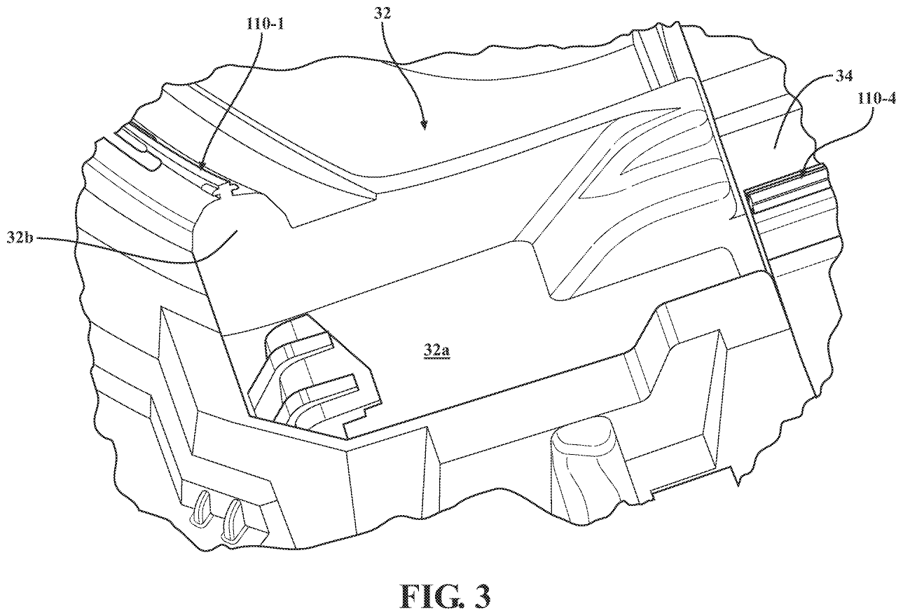

Referring to FIGS. 1, 2, 5, and 6, the weather seal retention system 33 may also include an outer guide block 40 structured to be positionable along a second side (in this case, the left side 30b) of the sunroof assembly 30 adjacent the first side 30a. The outer guide block 40 may include a base portion 40a and a support portion 40b. In one or more arrangements, the support portion 40b may be structured to supporting a weather seal retaining structure as described herein. The outer guide block base portion 40a may be structured to rest on (and be supported by) the housing base portion 32a (FIG. 3) when the outer guide block 40 is connected to the inner guide block 38 as described herein and assembled into the sunroof assembly 30.

In particular arrangements, the outer guide block 40 is structured to be coupled to a guide rail 34 extending along the second side 30b of the sunroof assembly 30 when the outer guide block 40 is incorporated into the sunroof assembly 30. Elements described herein are considered to be “coupled” to each other when attached to each other directly or indirectly, with or without physical contact, so as to enable the performance of any function relating to the coupling of the elements. In some aspects, the outer guide block 40 may include features (e.g., guide channels) enabling it to serve as an extension of the guide rail 34 when coupled to the guide rail. This may provide additional flexibility in controlling aspects of the motion of the movable glass sunroof panel.

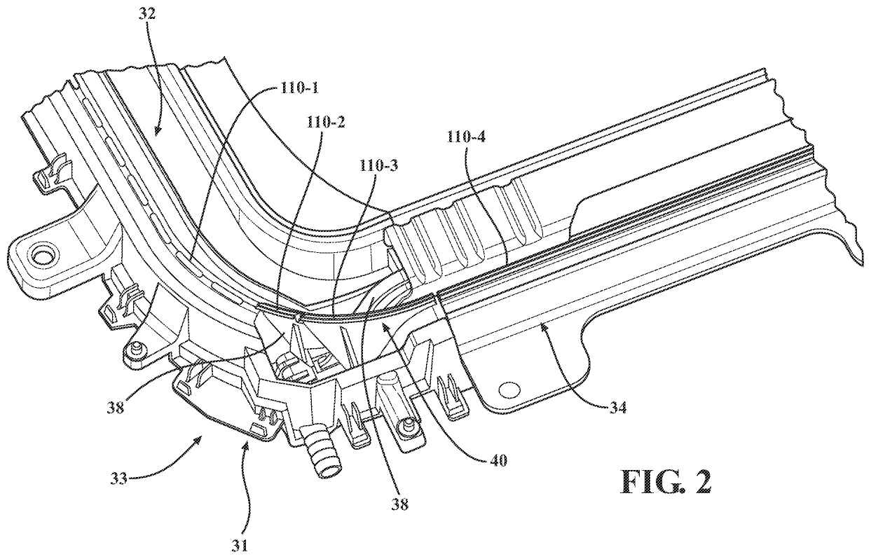

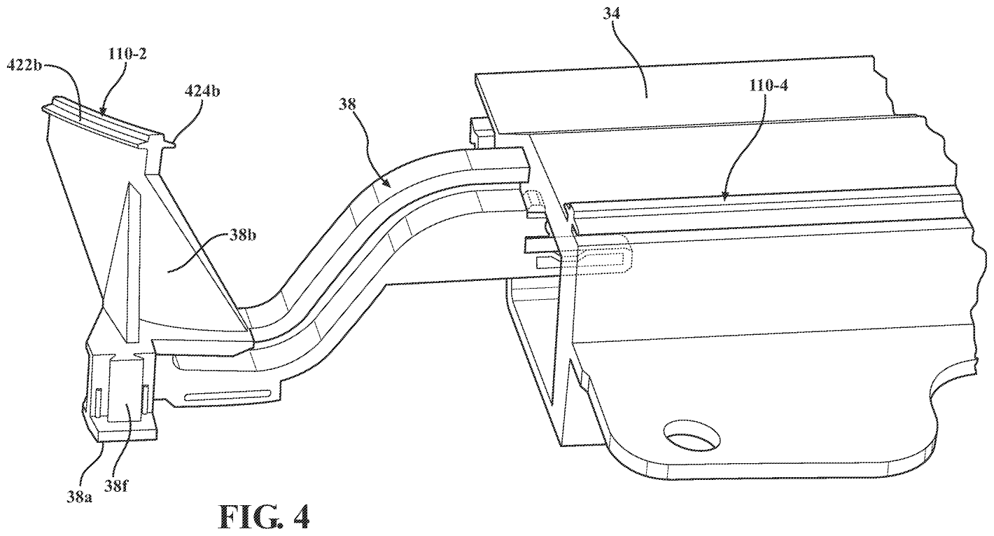

Referring to FIGS. 2, 4, 5, and 6, the weather seal retention system 33 may also include an inner guide block 38. In particular arrangements, the inner guide block 38 is structured to be coupled to the guide rail 34 when the inner guide block is incorporated into the sunroof assembly 30. In some aspects, the inner guide block 38 may also include features (e.g., guide channels) enabling it to serve as an extension of the guide rail 34 when coupled to the guide rail. This may provide additional flexibility in controlling aspects of the motion of the movable glass sunroof panel.

The inner guide block 38 may include a base portion 38a and a support portion 38b extending from the base portion 38a. In one or more arrangements, the support portion 38b may be structured to support a weather seal retaining structure as described herein.

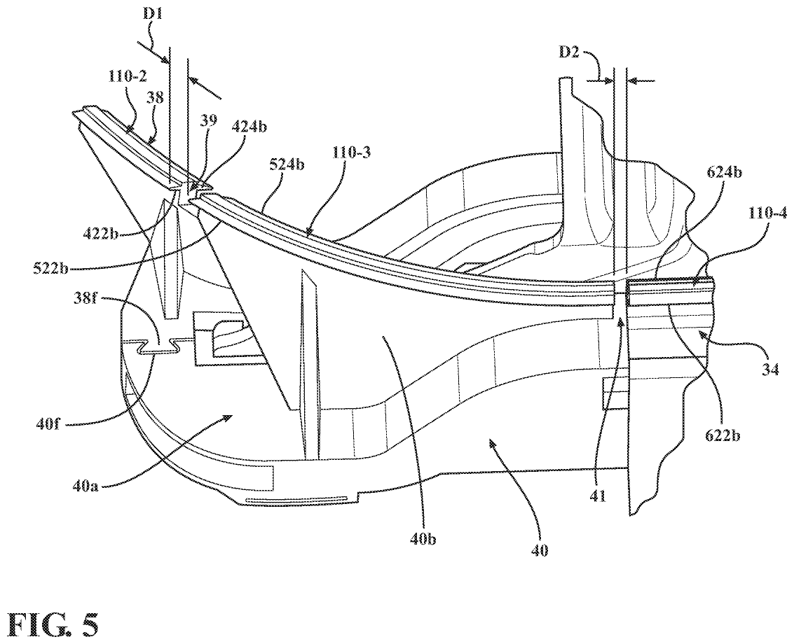

Referring to FIG. 3, the inner guide block base portion 38a may be structured to rest on (and be supported by) the housing base portion 32a when the inner guide block 38 is connected to the outer guide block 40 as described herein and assembled into the sunroof assembly 30. In addition, referring to FIG. 5, in particular arrangements, the inner guide block 38 is coupled to the outer guide block 40 so as to secure positions of the inner guide block 38 and outer guide block 40 with respect to each other. Any suitable coupling method or structure may be used. In the example shown in FIG. 5, a coupling structure including tongue-in-groove connection features 38f and 40f is employed.

In embodiments described herein, a system 33 structured to retain a weather seal along a transition portion 31 of a vehicle sunroof assembly 30 may incorporate weather seal retaining structures into the housing 32, the guide rail 34, and one or more of the inner guide block 38 and the outer guide block 40. In combination, these retaining structures operate to retain the weather seal in its functioning position along a transition portion 31 of the sunroof assembly 30. In one or more arrangements, the system 33 may include a first weather seal retaining structure structured to be positioned between a second weather seal retaining structure extending at least partially along the first side of the sunroof assembly 30 and a third weather seal retaining structure extending at least partially along the second side of the sunroof assembly 30 adjacent the first side.

In particular arrangements, the first weather seal retaining structure may be supported by the outer guide block 40. Specifically, the outer guide block support portion 40b may support a first weather seal retaining structure 110-3 as described herein. The weather seal retaining structure 110-3 of the outer guide block 40 may extend continuously and coextensively along an extent of the outer guide block support portion 40b to enable a weather seal 200 to be continuously and coextensively retained along the extent of the outer guide block support portion 40b. In addition, in such arrangements, the second weather seal retaining structure may be supported by the housing 32. For example, the housing support portion 32b a may support a second weather seal retaining structure 110-1 as described herein. Also, in such arrangements, the third weather seal retaining structure may be supported by the guide rail 34. For example, referring to FIGS. 1, 2, 5, and 6, a third weather seal retaining structure 110-4 may be supported by guide rail 34. The weather seal retaining structure 110-4 of the guide rail 34 may extend continuously and coextensively along a length of the guide rail to enable a weather seal 200 to be continuously and coextensively retained along the extent of the guide rail 34.

In some arrangements where the first weather seal retaining structure is supported on the outer guide block 40, the inner guide block 38 may not incorporate and support a retaining structure for securing the weather seal along the sunroof assembly transition portion 31. In other arrangements, as described elsewhere herein, the inner guide block 38 may incorporate and support an associated retaining structure.

In addition, in one or more arrangements, the first retaining structure includes a first retention surface and the second retaining structure includes a first retention surface. In addition, the first retaining structure first retention surface and the second retaining structure first retention surface may be structured to be coplanar when the first retaining structure and the second retaining structure are incorporated into the sunroof assembly 30. For example, referring to FIGS. 1-6, the first retaining structure 110-3 (supported by the outer guide block 40) includes a first retention surface 524b and the second retaining structure 110-1 (supported by housing 32) includes a first retention surface 124b. In addition, the first retaining structure first retention surface 524b and the second retaining structure first retention surface 124b may be structured to be coplanar when the first retaining structure 110-3 and the second retaining structure 110-1 are incorporated into the sunroof assembly.

Also, the first retaining structure may include a second retention surface and the second retaining structure may include a second retention surface. In addition, the first retaining structure second retention surface and the second retaining structure second retention surface may be structured to be coplanar when the first retaining structure and the second retaining structure are incorporated into the sunroof assembly. For example, in the embodiment shown in FIGS. 1-6, the first retaining structure 110-3 (supported by the outer guide block 40) includes a second retention surface 522b and the second retaining structure 110-1 (supported by housing 32) includes a second retention surface 122b. In addition, the first retaining structure second retention surface 522b and the second retaining structure second retention surface 122b may be structured to be coplanar when the first retaining structure 110-3 and the second retaining structure 110-1 are incorporated into the sunroof assembly 30.

In addition, in one or more arrangements, the third retaining structure 110-4 (supported on the guide rail 34) may include a first retention surface 624b, and the first retaining structure first retention surface 524b and the third retaining structure first retention surface 624b may be structured to be coplanar when the first retaining structure 110-3 and the third retaining structure 110-4 are incorporated into the sunroof assembly 30. Also, the third retaining structure 110-4 may include a second retention surface 622b, and the first retaining structure second retention surface 522b and the third retaining structure second retention surface 622b may be structured to be coplanar when the first retaining structure 110-3 and the third retaining structure 110-4 are incorporated into the sunroof assembly.

Referring to FIGS. 1-6, in other particular arrangements, the first weather seal retaining structure may be supported by the inner guide block 38. Specifically, the inner guide block support portion 38b may support an associated first weather seal retaining structure 110-2 as described herein. In such arrangements, and as previously described, the second weather seal retaining structure 110-1 may be supported by the housing 32. Also, in such arrangements, and as previously described, the third weather seal retaining structure may be supported by the guide rail 34.

In one or more arrangements, the weather seal retaining structure 110-2 of the inner guide block 38 may extend continuously and coextensively along an extent of the inner guide block support portion 38b to enable a weather seal 200 to be continuously and coextensively retained along the extent of the inner guide block support portion 38b.

In some arrangements where the first weather seal retaining structure is supported on the inner guide block 38, the outer guide block 40 may not incorporate and support a retaining structure for securing the weather seal along the sunroof assembly transition portion. In other arrangements, as described elsewhere herein, the outer guide block 40 may incorporate and support an associated retaining structure.

In addition, in one or more arrangements, and as previously described, the first retaining structure includes a first retention surface and the second retaining structure includes a first retention surface. In addition, the first retaining structure first retention surface and the second retaining structure first retention surface may be structured to be coplanar when the first retaining structure and the second retaining structure are incorporated into the sunroof assembly. For example, in the embodiment shown in FIGS. 1-6, the first retaining structure 110-2 (supported on the inner guide block 38) includes a first retention surface 424b and the second retaining structure 110-2 (supported on housing 32) includes the first retention surface 124b. In addition, the first retaining structure first retention surface 424b and the second retaining structure first retention surface 124b may be structured to be coplanar when the first retaining structure 110-2 and the second retaining structure 110-1 are incorporated into the sunroof assembly 30. Also, the first retaining structure may include a second retention surface and the second retaining structure may include a second retention surface. In addition, the first retaining structure second retention surface and the second retaining structure second retention surface may be structured to be coplanar when the first retaining structure and the second retaining structure are incorporated into the sunroof assembly 30. For example, in the embodiment shown in FIGS. 1-6, the first retaining structure 110-2 (supported by the inner guide block 38) includes a second retention surface 422b and the second retaining structure 110-1 (supported by housing 32) includes a second retention surface 122b. In addition, the first retaining structure second retention surface 422b and the second retaining structure second retention surface 122b may be structured to be coplanar when the first retaining structure 110-2 and the second retaining structure 110-1 are incorporated into the sunroof assembly 30.

In addition, in one or more arrangements, and as previously described, the third retaining structure 110-4 may include the first retention surface 624b, and the first retaining structure first retention surface 424b and the third retaining structure first retention surface 624b may be structured to be coplanar when the first retaining structure 110-2 and the third retaining structure 110-4 are incorporated into the sunroof assembly 30. Also, the third retaining structure 110-4 may include a second retention surface 622b, and the first retaining structure second retention surface 422b and the third retaining structure second retention surface 622b may be structured to be coplanar when the first retaining structure 110-2 and the third retaining structure 110-4 are incorporated into the sunroof assembly.

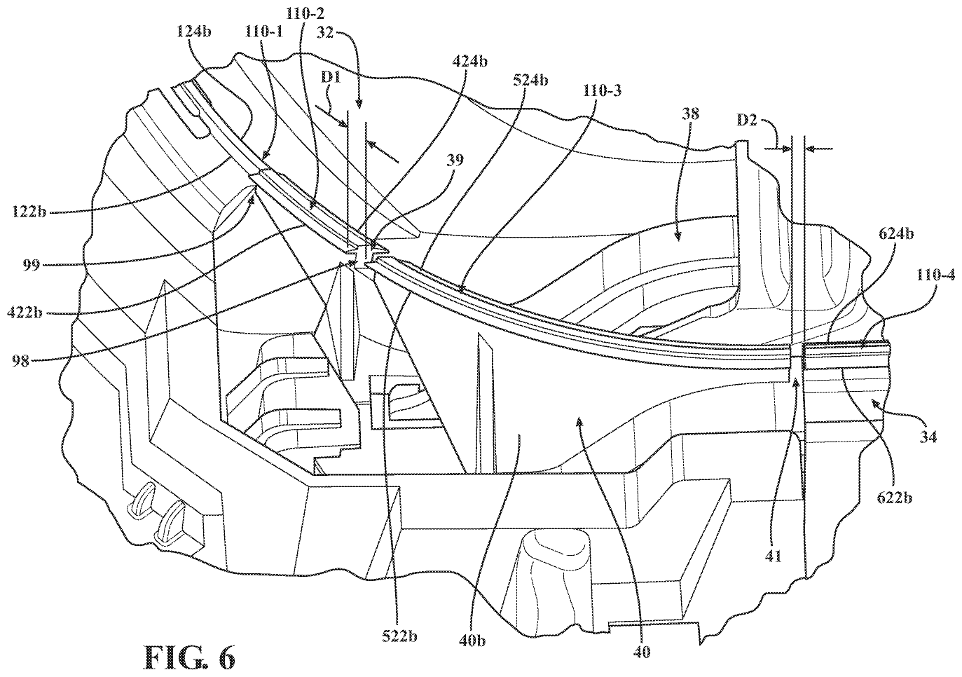

It certain arrangements, it may be desirable to minimize the gaps between retaining structures on adjacent elements of the weather seal retention system 33 to maximize the length of structure retaining the weather seal. Referring to FIG. 6, in particular arrangements where the first retaining structure is supported on the inner guide block 38, the first retaining structure 110-2 and the second retaining structure 110-1 (supported on housing 32) may be structured to physically contact each other when the housing 32 and the inner guide block 38 are incorporated into the sunroof assembly 30. This may aid in maximizing weather seal retention along the transition portion 31.

Referring again to FIGS. 1-6, in particular arrangements, the weather seal retention system may also include another weather seal retaining structure structured to be positioned between either the first weather seal retaining structure and the second weather seal retaining structure, or between the first weather seal retaining structure and the third weather seal retaining structure. For example, in an arrangement where the outer guide block 40 supports a first weather seal retaining structure 110-3 as shown in FIG. 5, another weather seal retaining structure 110-2 may be supported on the inner guide block 38 so as to be positioned between the first weather seal retaining structure 110-3 and the second weather seal retaining structure 110-1 supported by the housing 32 when the first retaining structure, the second retaining structure, and the other retaining structure are incorporated into the sunroof assembly. In such arrangements, as previously described, the first retaining structure 110-3 (supported on the outer guide block 40) may include a first retention surface 524b. In addition, the other retaining structure 110-2 (supported on the inner guide block 38) may include a first retention surface 424b. The first retaining structure first retention surface 524b and the other retaining structure first retention surface 424b may be structured to be coplanar when the first retaining structure 110-3 and the other retaining structure 110-2 are incorporated into the sunroof assembly 30.

Also, the first retaining structure 110-3 may also include a second retention surface 522b. In addition, the other retaining structure may include a second retention surface 422b. The first retaining structure second retention surface 522b and the other retaining structure second retention surface 122b may be structured to be coplanar when the first retaining structure 110-3 and the other retaining structure 110-2 are incorporated into the sunroof assembly 30.

In addition, when the other retaining structure is supported on the inner guide block 38, the other retaining structure 110-2 and the second retaining structure 110-1 may be structured to physically contact each other when the housing 32 and the inner guide block 38 are incorporated into the sunroof assembly 30. This may aid in maximizing weather seal retention along the transition portion 31.

Also, referring to FIGS. 5 and 6, when inner guide block 38, the outer guide block 40, and the guide rail 34 are incorporated into the sunroof assembly 30, a small space or gap 39 may remain between the inner guide block 38 and the outer guide block 40 at their respective retaining structures 110-2 and 110-3 due to operational, positional, and tolerance requirements of these components. In particular arrangements, the gap 39 has a dimension D1 in the range of 4 millimeters or less.

In addition, a small space or gap 41 may remain between the outer guide block 40 and the guide rail 34 at their respective retaining structures 110-3 and 110-4 due to operational, positional, and tolerance requirements of these components. In particular arrangements, the gap 41 has a dimension D2 in the range of 4 millimeters or less.

Alternatively, in arrangements where the inner guide block 38 supports the first weather seal retaining structure 110-2 as shown in FIGS. 5 and 6, another weather seal retaining structure 110-3 may be supported on the outer guide block 40 so as to be positioned between the first weather seal retaining structure 110-2 and the third weather seal retaining structure 110-4 supported by the guide rail 34, when the first retaining structure, the third retaining structure, and the other retaining structure are incorporated into the sunroof assembly. In such arrangements, as previously described, the first retaining structure (supported on the inner guide block 38) may include first retention surface 424b. In addition, the other retaining structure 110-3 (supported on the outer guide block 40) may include a first retention surface 524b. The first retaining structure first retention surface 424b and the other retaining structure first retention surface 524b may be structured to be coplanar when the first retaining structure 110-2 and the other retaining structure 110-3 are incorporated into the sunroof assembly 30.

Also, as previously described, the first retaining structure 110-2 may include a second retention surface 422b. In addition, the other retaining structure 110-3 may include a second retention surface 522b. The first retaining structure second retention surface 422b and the other retaining structure second retention surface 522b may be structured to be coplanar when the first retaining structure 110-2 and the other retaining structure 110-3 are incorporated into the sunroof assembly.

Also, as stated previously, a small space or gap 41 may remain between the outer guide block 40 and the guide rail 34 at their respective retaining structures 110-3 and 110-4 due to operational, positional, and tolerance requirements of these components. In particular arrangements, the gap 41 has a dimension D2 in the range of 4 millimeters or less.

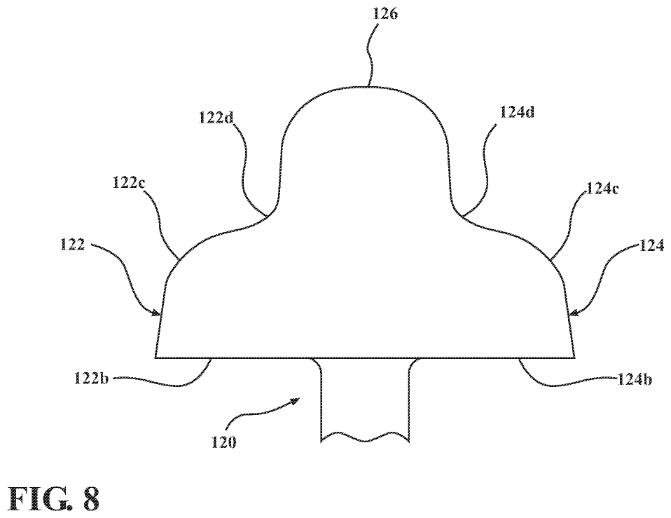

FIG. 8 is a schematic end view of the retaining structure 110-1 in accordance with an embodiment described herein. In the following, only the retaining structure 110-1 incorporated into the housing 32 will be described in detail. However, it will be understood that retaining structure 110-2 incorporated into the inner guide block 38, retaining structure 110-3 incorporated into the outer guide block 40, and retaining structure 110-4 incorporated into the guide rail 34 may have the same structure as the retaining structure 110-1. Thus, the following disclosure will describe retaining structures 110-1, 110-2, 110-3, and 110-4.

Referring to FIG. 8, retaining structure 110-1 may include a spine 120 with at least a first and a second opposed weather seal retention projections 122, 124 extending from respective opposite first and second sides 120a, 120b of the spine 120 to form a “T”-shaped cross-section. In one or more arrangements, the spine 120 and weather seal retention projections 122, 124 may extend continuously and coextensively along an extent of the housing support portion 32b to enable a weather seal (not shown) to be continuously and coextensively retained along the extent of the housing support portion 32b. In other arrangements, a plurality of spaced apart pairs of opposed retention projections 122, 124 may extend from the spine 120 along a length of the spine. In some arrangements, successive spaced apart pairs of opposed retention projections 122, 124 may be spaced apart evenly along at least a portion of a length of the spine 120.

In particular arrangements, weather seal retention projections 122, 124 may extend to an end of the housing 32 structured to reside adjacent the inner guide block 38 when the housing 32 and the inner guide block 38 are incorporated into the sunroof assembly 30. This may enable the retaining structure 110-1 of housing 32 to physically contact the retaining structure 110-2 of inner guide block 38 when the housing 32 and the inner guide block 38 are incorporated into the sunroof assembly 30.

Referring to FIG. 8, in one or more arrangements, a shape of the spine 120 along a cross-section taken through the opposed first and second retention projections 122, 124 may include a first retention surface 124b extending perpendicularly from the first side 120a of the spine 120. A second retention surface 122b may extend perpendicularly from the second side 120b of the spine 120 opposite the first retention surface 124b. The first and second retention surfaces 124b, 122b of the respective retention projections 124, 122 may be structured to contact associated respective first and second ledges 212a. 210a formed on the weather seal 200 (described in greater detail below) when the weather seal 200 is mounted on the spine 120, to retain the weather seal 200 on the housing 32. In one or more arrangements, the first retention surface 124b and the second retention surface 122b are coplanar.

Referring again to FIG. 8, a first edge portion 124c may extend perpendicularly from the first retention surface 124b and a second edge portion 122c may extend perpendicularly from the second retention surface 122b opposite the first edge portion 124c. A first chamfered portion 124d may extend from the first edge portion 124c toward a head portion 126 of the spine 120, and a second chamfered portion 122d may extend from the second edge portion 122c toward the spine head portion 126. The second chamfered portion 122d may reside opposite the first chamfered portion 124d. The chamfered portions 124d, 122d may provide lead-in surfaces to facilitate mounting of the weather seal 200 on the spine 120. In some arrangements, an intersection between the first chamfered portion 124d and the spine head 126 may be radiused. Similarly, an intersection between the second chamfered portion 122d and the spine head 126 may be radiused.

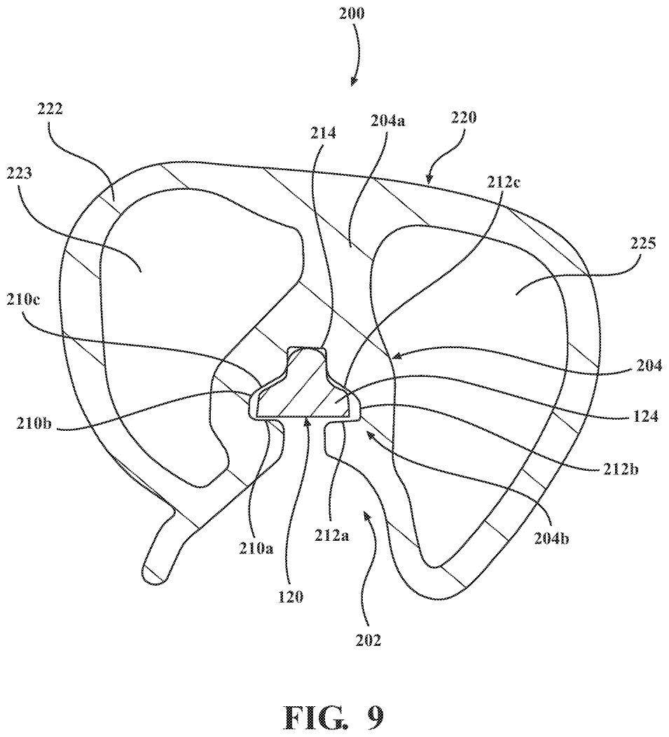

FIG. 9 is a partial cross-sectional view showing a weather seal 200 mounted and retained on the spine 120 of retaining structure 110-1 just described, and showing details of the weather seal 200. Materials of manufacture and/or material surface finishes for the weather seal 200 may include resiliently deformable materials to which water has a relatively high adhesion, and also which are suitable for forming a seal or weather-stripping around openings on a vehicle. A high adhesion may cause moisture to adhere to the outer surface of the weather seal and migrate along the seal until it falls off the seal and onto another portion of the sunroof assembly or onto the vehicle roof for drainage. Possible materials include EPDM rubber, thermoplastic elastomer mixes of rubber and plastic, thermoplastic olefin polymer/filler blends, thermoplastic styrene polymer/filler blends, vinyl chloride resins, and any other suitable material. The weather seal 200 may be formed by extrusion or by any other suitable method or methods.

In one or more arrangements, the weather seal 200 may include a trunk 204 defining a retention portion 202, and a seal portion 220 extending from the retention portion 202 to contact another portion of the vehicle so as to form a seal therebetween. The trunk 204 may have a relatively narrower first end 204a and relatively wider second end 204b formed opposite the first end 204a. The trunk second end 204b may define a retention cavity 206. The retention cavity 206 may be shaped so as to conform to the shape of a cross-section of the spine 120 through the retention projections 122, 124 as previously described, to enable portions of the trunk 204 to engage or grip associated portions of the spine 320, including the retention projections 122, 124. For example, referring to FIG. 9, the retention cavity 206 may include a first ledge 212a structured to abut the spine first retention surface 124b when the weather seal 200 is mounted on the spine 120. A first sidewall 212b may extend from the first ledge 212a and may be positioned opposite the spine first edge portion 124c. A first sloped portion 212c may extend from the first sidewall 212b and may be positioned opposite the spine first chamfered portion 124d. A spine head receptacle portion 214 may be formed adjacent the first sloped portion 212c and may be structured to receive the spine head 126 therein.

In addition, the retention cavity 206 may also include a second ledge 210a structured to abut the spine second retention surface 122b when the weather seal 200 is mounted on the spine 120. A second sidewall 210b may extend from the second ledge 210a and may be positioned opposite the spine second edge portion 122c. A second sloped portion 210c of the retention cavity 206 may extend from the second sidewall 210b and may be positioned opposite the spine second chamfered portion 122d. The second sloped 210c portion may also be positioned adjacent the spine head receptacle portion 214.

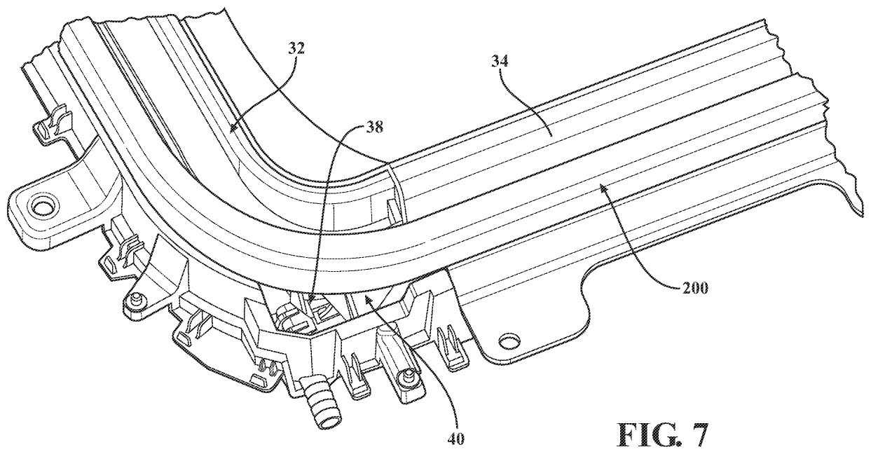

FIG. 5 is a schematic perspective view of the inner guide block 38 and the outer guide block 40, showing the inner guide block 38 and the outer guide block 40 coupled together by a tongue-and-groove arrangement. FIG. 6 is a schematic perspective view similar to the view of FIG. 5, with the housing 32, inner guide block 38, and outer guide block 40 of the weather seal retention system 33 shown in their relative positions in the sunroof assembly 30. Referring to FIGS. 5 and 6, as previously described, the second retaining structure 110-1 of housing 32 may include first retention surface 124b and second retention surface 122b. Also, the retaining structure 110-3 of outer guide block 40 may include first retention surface 524b and second retention surface 522b. In addition, the retaining structure 110-2 of inner guide block 38 may include first retention surface 424b and second retention surface 422b. Also, the third retaining structure 110-4 of guide rail 34 may include first retention surface 624b and second retention surface 622b. In addition, as previously described, the housing 32, the inner guide block 38, the outer guide block 40 and the guide rail 34 may be structured so that their respective retaining structures are coplanar (i.e., such that similar portions of the respective retaining structures 110-1, 110-2, 110-3 and 110-4 are coplanar (within the dimensional tolerance limits of the associated components) when the housing 32, inner guide block 38, and outer guide block 40 and the guide rail 34 are incorporated into the sunroof assembly 30). Thus, when arranged as shown in the drawings, the retaining structure 110-1, the retaining structure 110-4, and one or both of the retaining structures 110-2 and 110-3 may cooperate to retain the weather seal 200 along the transition portion 31 of the sunroof assembly. FIG. 7 is a schematic perspective view similar to the view of FIG. 6, showing a weather seal secured to the elements of the weather seal retention system 33.

In further aspects, a sunroof assembly for a vehicle may be provided, including an embodiment of a weather seal retention system described herein.

Detailed embodiments are disclosed herein. However, it is to be understood that the disclosed embodiments are intended only as examples. Therefore, specific structural and functional details disclosed herein are not to be interpreted as limiting, but merely as a basis for the claims and as a representative basis for teaching one skilled in the art to variously employ the aspects herein in virtually any appropriately detailed structure. Further, the terms and phrases used herein are not intended to be limiting but rather to provide an understandable description of possible implementations. Various embodiments are shown in FIGS. 1-9, but the embodiments are not limited to the illustrated structure or application.

While recited characteristics and conditions of the invention have been described in connection with certain embodiments, it is to be understood that the invention is not to be limited to the disclosed embodiments but, on the contrary, is intended to cover various modifications and equivalent arrangements included within the spirit and scope of the appended claims, which scope is to be accorded the broadest interpretation so as to encompass all such modifications and equivalent structures as is permitted under the law.

What is claimed is:

1. A system structured to retain a weather seal along a transition portion of a vehicle sunroof assembly, the system comprising a first weather seal retaining structure structured to be positioned between a second weather seal retaining structure extending at least partially along a first side of the sunroof assembly and a third weather seal retaining structure extending at least partially along a second side of the sunroof assembly adjacent the first side.

2. The system of claim 1, wherein the first retaining structure includes a first retention surface and the second retaining structure includes a first retention surface, and wherein the first retaining structure first retention surface and the second retaining structure first retention surface are structured to be coplanar when the first retaining structure and the second retaining structure are incorporated into the sunroof assembly.

3. The system of claim 2, wherein the first retaining structure includes a second retention surface and the second retaining structure includes a second retention surface, and wherein the first retaining structure second retention surface and the second retaining structure second retention surface are structured to be coplanar when the first retaining structure and the second retaining structure are incorporated into the sunroof assembly.

4. The system of claim 2, wherein the third retaining structure includes a first retention surface, and wherein the first retaining structure first retention surface and the third retaining structure first retention surface are structured to be coplanar when the first retaining structure and the third retaining structure are incorporated into the sunroof assembly.

5. The system of claim 4, wherein the third retaining structure includes a second retention surface, and wherein the first retaining structure second retention surface and the third retaining structure second retention surface are structured to be coplanar when the first retaining structure and the third retaining structure are incorporated into the sunroof assembly.

6. The system of claim 1, wherein the second retaining structure is supported on a housing structured to extend at least partially along the first side of the sunroof assembly, and wherein the first retaining structure is supported on an inner guide block structured to be positioned adjacent the housing.

7. The system of claim 1, wherein the third retaining structure is supported on a guide rail structured to extend at least partially along the second side of the sunroof assembly, and wherein the first retaining structure is supported on an outer guide block structured to be positioned adjacent the guide rail.

8. The system of claim 1, further comprising another weather seal retaining structure structured to be positioned between the first weather seal retaining structure and the second weather seal retaining structure when the first retaining structure, the second retaining structure, and the other retaining structure are incorporated into the sunroof assembly.

9. The system of claim 8, wherein the second retaining structure and the other retaining structure are structured to physically contact each other when the other retaining structure and the second retaining structure are incorporated into the sunroof assembly.

10. The system of claim 8, wherein the first retaining structure includes a first retention surface and the other retaining structure includes a first retention surface, and wherein the first retaining structure first retention surface and the other retaining structure first retention surface are structured to be coplanar when the first retaining structure and the other retaining structure are incorporated into the sunroof assembly.

11. The system of claim 10, wherein the first retaining structure includes a second retention surface and the other retaining structure includes a second retention surface, and wherein the first retaining structure second retention surface and the other retaining structure second retention surface are structured to be coplanar when the first retaining structure and the other retaining structure are incorporated into the sunroof assembly.

12. The system of claim 8, wherein the other retaining structure has a “T”-shaped cross-section.

13. The system of claim 1, further comprising another weather seal retaining structure structured to be positioned between the first weather seal retaining structure and the third weather seal retaining structure when the first retaining structure, the third retaining structure, and the other retaining structure are incorporated into the sunroof assembly.

14. The system of claim 13, wherein the first retaining structure is supported on an inner guide block of the sunroof assembly, the other retaining structure is supported on an outer guide block of the sunroof assembly, and wherein the inner guide block is coupled to the outer guide block so as to secure positions of the inner guide block and outer guide block with respect to each other.

15. The system of claim 13, wherein a gap is formed between the other retaining structure and the third retaining structure when the third retaining structure and the other retaining structure are incorporated into the sunroof assembly.

16. The system of claim 15, wherein the gap has a dimension in a range of 4 millimeters or less.

17. The system of claim 13, wherein the first retaining structure includes a first retention surface and the other retaining structure includes a first retention surface, and wherein the first retaining structure first retention surface and the other retaining structure first retention surface are structured to be coplanar when the first retaining structure and the other retaining structure are incorporated into the sunroof assembly.

18. The system of claim 17, wherein the first retaining structure includes a second retention surface and the other retaining structure includes a second retention surface, and wherein the first retaining structure second retention surface and the other retaining structure second retention surface are structured to be coplanar when the first retaining structure and the other retaining structure are incorporated into the sunroof assembly.

19. The system of claim 16, wherein the other retaining structure has a “T”-shaped cross-section.

20. The system of claim 1, wherein each of the first, second, and third retaining structures has a “T”-shaped cross-section.
